(19) United States
(12) Patent Application Publication
(10) Pub. No.: US 2003/0195945 A1
(43) Pub. Date: Oct. 16, 2003

(54) Server for information retrieval system and terminal device

(75) Inventors: Tsutomu Honda, Sakai-shi (JP); Nobuyoshi Suzuki, Ashiya-shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/390,372

(22) Filed: Mar. 17, 2003

(30) Foreign Application Priority Data
Mar. 27, 2002 (JP) P2002-87798

(51) Int. Cl. H04N 7/173; G06F 15/16

(52) U.S. Cl. 709/219; 725/114; 725/131

(57) ABSTRACT

The present invention provides a server for an information retrieval system capable of performing an information retrieval based on an image to thereby accurately answer what an object in an image is and lessen the burden on the user. A terminal device transmits retrieval information including an image of an object the user does not know and attribute information regarding the image to a server. The server receives the retrieval information, and an information retrieval apparatus selecting unit selects an information retrieval apparatus as an object to which the retrieval information is transmitted from a plurality of information retrieval apparatuses by referring to reference information on the basis of the attribute information. As the reference information, information regarding specialty or the like of each information retrieval apparatus is stored. The information retrieval apparatus selects the information retrieval apparatus in consideration of the specialty or the like of each information retrieval apparatus. By transmitting the retrieval information to the selected information retrieval apparatus, the information retrieval apparatus requested to perform the information retrieval executes the information retrieval based on the image (retrieval for answering what the object in the image is).

This application is based on application No. 2002-087798 filed in Japan, the contents of which are hereby incorporated by reference.

### BACKGROUND OF THE INVENTION

1. Field of the Invention

The present invention relates to a server for an information retrieval system and a terminal device for performing an information retrieval based on an image.

2. Description of the Background Art

An image of a digital camera can be recognized on the spot of image capturing. Consequently, the user of a digital camera can take a picture of a matter (object) he/she does not know on the outside, go home and consult an illustrated reference book or perform a search on the Internet while recognizing the image in order to know what the object is. For example, in the case where the user takes a picture of a beautiful bird, by consulting an illustrated reference book or the like while checking it against the image, the user can know the name and the like of the bird.

When the user judges what the object is by himself/herself, however, there is a problem such that accuracy is low. For example, in the case of taking a picture of a bird, even if the user having poor knowledge of birds identifies the name, it is doubtful that the name is correct or not.

Moreover, it is inconvenient for the user of a digital camera to perform a search based on the image by himself/herself at home or the like.

### SUMMARY OF THE INVENTION

The present invention is directed to a server for an information retrieval.

According to the present invention, a server comprises: a first interface for performing data communication with a plurality of terminal devices; a second interface for performing data communication with a plurality of information retrieval apparatuses; an input unit for inputting retrieval information including an image from at least one of the plurality of terminal devices via the first interface; a selector for selecting at least one information retrieval apparatus as an object to which the retrieval information is transmitted from the plurality of information retrieval apparatuses on the basis of the retrieval information inputted from the input unit; a first transmitter for transmitting the retrieval information to the information retrieval apparatus selected by the selector via the second interface; a receiver for receiving retrieval result information via the second interface from the information retrieval apparatus to which the retrieval information is transmitted from the first transmitter; and a second transmitter for transmitting the retrieval result information via the first interface to the terminal device which has transmitted the retrieval information.

With the configuration, information retrieval service based on an image can be provided by the function of the server without burdening a load on the user of a terminal device. In addition, reliable reply information can be obtained and an efficient search can be performed.

According to one aspect of the present invention, after a lapse of predetermined time since transmission of the retrieval information, the first transmitter further transmits information indicating that it is unnecessary to perform a search to the information retrieval apparatus selected by the selector.

Consequently, the information retrieving process can be prevented from being performed forever in the information retrieval apparatus also after a lapse of the predetermined time.

According to another aspect of the present invention, when a predetermined number of items of retrieval result information are received from the information retrieval apparatus, the first transmitter further transmits information indicating that it is unnecessary to perform a search to the information retrieval apparatus selected by the selector.

With the configuration, also in the case where the necessary number of items of replay information is obtained, the information retrieving process can be prevented from being performed permanently in the information retrieval apparatus.

According to still another aspect of the present invention, the server further comprises: a detector for detecting information regarding the image included in the retrieval information; and a memory for storing reference information with which each of the plurality of information retrieval apparatuses is associated in accordance with the information regarding the image detected by the detector. The selector selects at least one information retrieval apparatus as an object to which the retrieval information is transmitted on the basis of the information regarding the image and the reference information.

Consequently, selection based on specialization or the like of the information retrieval apparatuses can be made in consideration of information of an image, so that reliable replay information can be obtained and an efficient search can be performed.

The present invention is also directed to an information retrieving method in a server for performing data communication with a plurality of terminal devices via a first interface and performing data communication with a plurality of information retrieval apparatuses via a second interface.

According to the present invention, the information retrieving method comprises the steps of: receiving retrieval information including an image from at least one of the plurality of terminal devices via the first interface; selecting at least one information retrieval apparatus as an object to which the retrieval information is transmitted from the plurality of information retrieval apparatuses on the basis of the retrieval information inputted; transmitting the retrieval information to the information retrieval apparatus selected via the second interface; receiving retrieval result information via the second interface from the information retrieval apparatus to which the retrieval information has been transmitted; and transmitting the retrieval result information via the first interface to the terminal device which has transmitted the retrieval information.

The present invention is also directed to a terminal device capable of performing data communication via a network with a server which performs data communication with a plurality of information retrieval apparatuses.

According to the present invention, the terminal device comprises: an image input unit for inputting an image; a detector for detecting information regarding the image received from the image input unit; a retrieval information generator for generating retrieval information including the image received from the image input unit and the information regarding the image detected by the detector; and a transmitter for transmitting the retrieval information generated by the retrieval information generator to the server.

With the configuration, the terminal device can make a retrieving process efficiently executed via the server. A retrieval result based on not only an image but also information can be obtained, so that reliable reply information can be obtained.

The present invention is also directed to a method of generating retrieval information in a terminal device capable of performing data communication via a network with a server performing data communication with a plurality of information retrieval apparatuses.

According to the present invention, the method of generating retrieval information comprises the steps of: inputting an image; detecting information regarding the image inputted; generating retrieval information including the image inputted and information regarding the image detected; and transmitting the retrieval information generated to the server.

As described above, an object of the present invention is to provide a technique for configuring an information retrieval system capable of retrieving information on the basis of an image, accurately replying what the image is, and reducing a load on the user.

These and other objects, features, aspects and advantages of the present invention will become more apparent from the following detailed description of the present invention when taken in conjunction with the accompanying drawings.

### DESCRIPTION OF THE DRAWINGS

FIG. 1 is a configuration diagram of an information retrieval system according to a preferred embodiment of the present invention;

FIG. 2 is a configuration diagram showing a case where a terminal device is a computer;

FIG. 3 is a configuration diagram showing a case where the terminal device is a digital camera;

FIG. 4 is a configuration diagram showing a case where the terminal device is a dedicated terminal device;

FIG. 5 is a block diagram showing the configuration of a server;

FIG. 6 is a block diagram showing an example of the configuration of an information retrieval apparatus;

FIG. 7 is a block diagram showing an example of the configuration of the information retrieval apparatus;

FIG. 8 is a block diagram showing an example of the configuration of the information retrieval apparatus;

FIG. 9 is a flowchart showing a processing sequence for transmitting retrieval information from a terminal device (computer);

FIG. 10 is a flowchart showing a processing sequence for transmitting retrieval information from a terminal device (digital camera);

FIG. 11 is a flowchart showing a processing sequence for transmitting retrieval information from a terminal device (dedicated terminal device);

FIG. 12 is a flowchart showing a processing sequence in the case of receiving answer information by the terminal device;

FIG. 13 is a flowchart showing a processing sequence for retrieval in a server;

FIG. 14 is a flowchart showing a processing sequence for retrieval in the server;

FIG. 15 is a flowchart showing a processing sequence for retrieval in the server;

FIG. 16 is a block diagram showing the configuration of an information retrieval system realizing a first billing form;

FIG. 17 is a flowchart showing a processing sequence for realizing the first billing form in the server;

FIG. 18 is a flowchart showing a processing sequence for realizing the first billing form in the server;

FIG. 19 is a flowchart showing a processing sequence for realizing the first billing form in the server;

FIG. 20 is a block diagram showing the configuration of an information retrieval system realizing a second billing form; and

FIG. 21 is a diagram showing a modification of the case where the terminal device is a digital camera.

### DESCRIPTION OF THE PREFERRED EMBODIMENTS

Hereinafter, preferred embodiments of the present invention will be described in detail with reference to the drawings.

1. General Configuration of Information Retrieval System

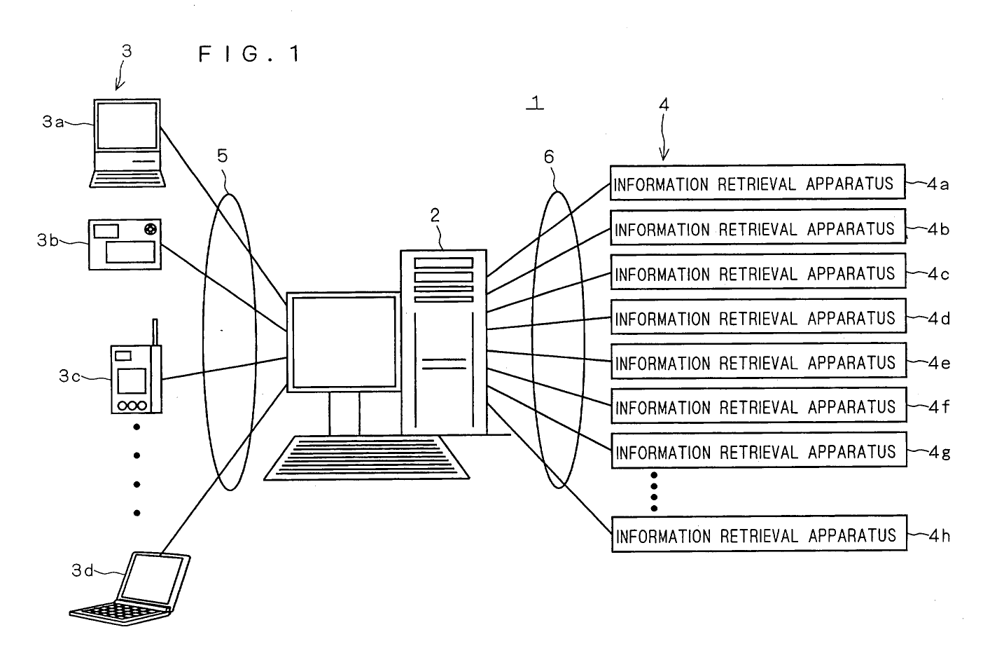

FIG. 1 is a configuration diagram of an information retrieval system 1 according to a preferred embodiment of the present invention. As shown in FIG. 1, the information retrieval system 1 has a server 2 for the information retrieval system (hereinafter, simply referred to as server), a plurality of terminal devices 3 (3a, 3b, 3c, 3d, . . . ), and a plurality of information retrieval apparatuses 4 (4a, 4b, 4c, . . . ). The server 2 and the plurality of terminal devices 3 are connected to each other so as to transmit/receive data to/from each other via a network 5, and the server 2 and the plurality of information retrieving apparatuses 4 are connected to each other so as to transmit/receive data to/from each other via a network 6.

Each terminal device 3 takes the form of personal computers 3a and 3d, a digital camera 3b, a dedicated terminal device 3c for the information retrieval system, or the like and is connected to the network 5 by wire or by radio to perform data communication with the server 2.

Each of the information retrieval apparatuses 4 has a function of providing information retrieval service based on an image in a specific image field (retrieval service for answering what is an object in an image) and is connected to the network 6 by wire or by radio to perform data communication with the server 2.

Each of the networks 5 and 6 may be a network such as the Internet or a network connected to the server 2 via a dedicated line or the like.

In the information retrieval system 1 constructed as described above, in the case where the user of the terminal device 3 obtains an image of an object the user does not know, retrieval information including the image is generated in the terminal device 3 and transmitted to the server 2. In the server 2, reference information of which field indicative of specialty in information retrieval service of each information retrieval apparatus 4 is prestored. When retrieval information is received from the terminal device 3, on the basis of the retrieval information, the server 2 specifies an information retrieval apparatus allowed to perform a retrieval from the plurality of information retrieval apparatuses 4. The server 2 transmits the retrieval information to the specified information retrieval apparatus so that an information retrieval based on the image is executed in the specified information retrieval apparatus 4, and obtains answer information indicating what the object in the image is. The answer information is transmitted from the server 2 to the terminal device 3 and the user of the terminal device 3 can easily grasp what is the object in the image the user did not know.

That is, in the information retrieval system 1 is a system in which, only by transmitting the retrieval information including at least an image from the terminal device 3, the user can get an answer what is the object in the image.

2. Configuration of Terminal Device

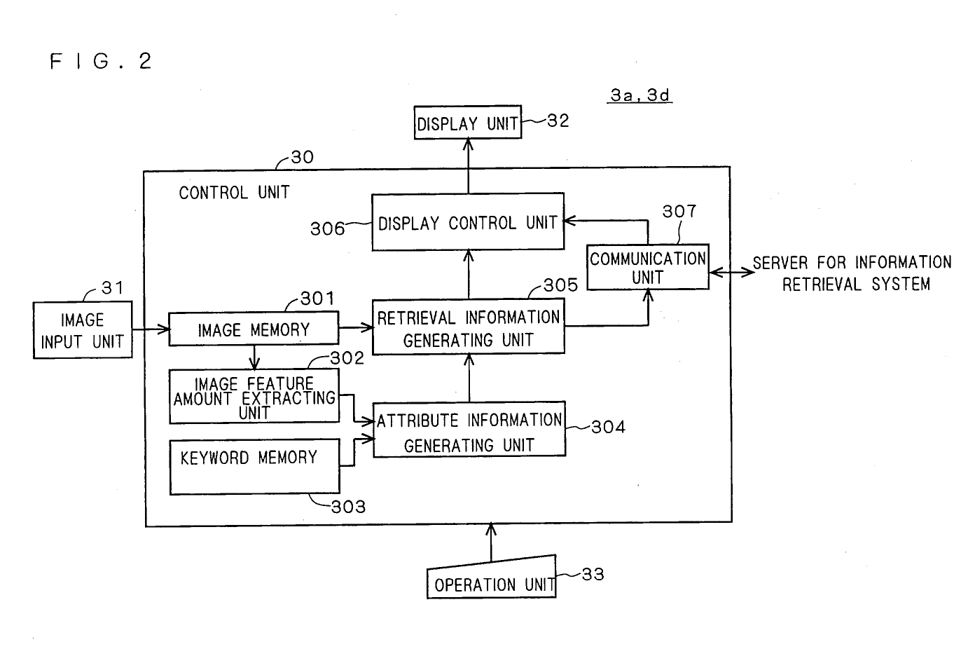

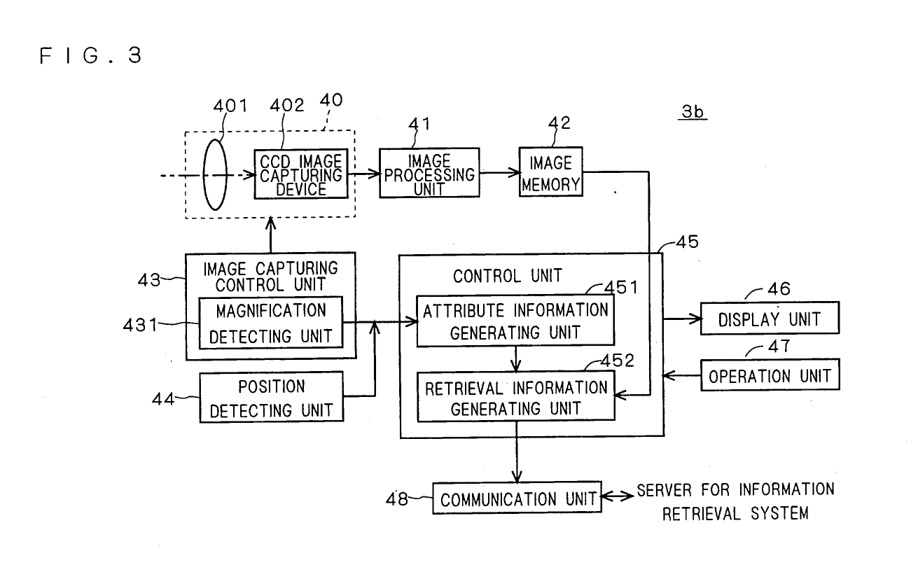

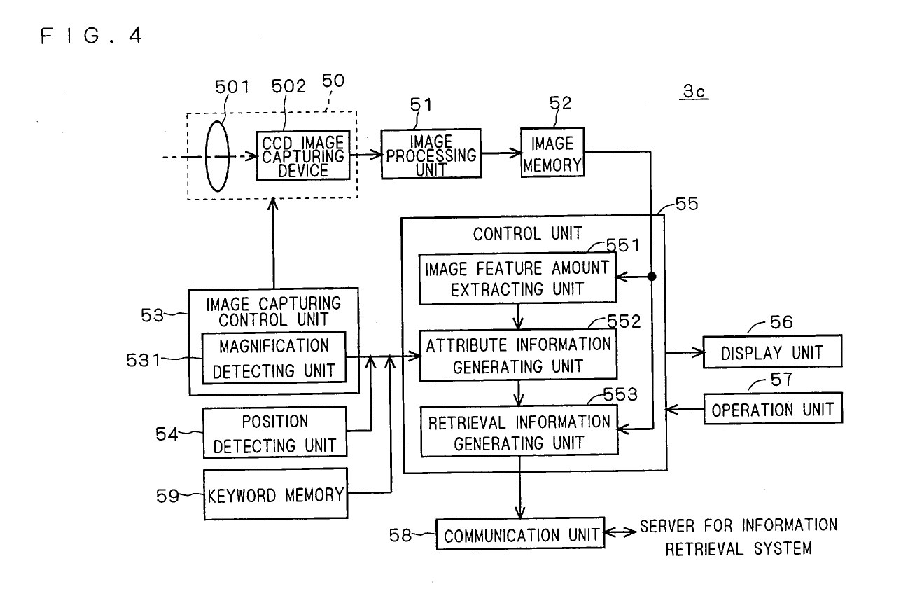

FIGS. 2 to 4 are diagrams showing an example of the terminal device 3. FIG. 2 shows an example where the terminal device 3 takes the form of the personal computer 3a or 3d. FIG. 3 shows an example where the terminal device 3 takes the form of the digital camera 3b. FIG. 4 shows an example where the terminal device 3 takes the form of the dedicated terminal device 3c.

First, the case where the terminal device 3 takes the form of a personal computer as shown in FIG. 2 will be described. In this case, the terminal device 3a or 3d includes a control unit 30, an image input unit 31, a display unit 32 and an operation unit 33.

The image input unit 31 is an input unit for inputting image data from a recording medium such as a memory card or a CD-ROM. Image data inputted from the image input unit 31 is supplied to the control unit 30. The display unit 32 is a display unit constructed by a CRT, a liquid crystal display or the like and data to be displayed on the display unit 32 is controlled by the control unit 30. The operation unit 33 includes a keyboard, a mouse and the like and supplies the information which is inputted by the operation of the user to the control unit 30.

The control unit 30 is realized when a CPU executes a predetermined program. In order to perform an information retrieval based on an image, the control unit 30 functions as an image memory 301, an image feature amount extracting unit 302, a keyword memory 303, an attribute information generating unit 304, a retrieval information generating unit 305, a display control unit 306 and a communication unit 307.

The image memory 301 is a memory for temporarily storing image data inputted from the image input unit 31 and outputs image data to the image feature amount extracting unit 302 and the retrieval information generating unit 305.

The image feature amount extracting unit 302 extracts a feature amount (for example, an outer shape, color or the like of an object included in an image). Concretely, by performing a contour extracting process on image data obtained from the image memory 301, the outer shape of the object is extracted, a color distribution in the outer shape is obtained, and the outer shape and the color distribution are used as feature amounts of the image. The feature amounts of the image extracted by the image feature amount extracting unit 302 are supplied to the attribute information generating unit 304.

The keyword memory 303 is a memory in which a number of terms are stored and a list of the terms stored in the keyword memory 303 is displayed on the display unit 32 by the control unit 30. The user selects a term from the list of the number of terms displayed on the display unit 32, which is estimated from the object included in the image. The selecting operation by the user is performed on the operation unit 33. As a result, the term selected by the user is supplied as a keyword of the image to the attribute information generating unit 304.

A keyword may be set in the attribute information generating unit 304 not only by selecting a keyword from the keyword memory 303 but also by inputting an arbitrary keyword to the operation unit 33 by the user.

When the feature amount of the image obtained from the image feature amount extracting unit 302 and the keyword which is set by the user's selecting operation or the like are inputted, the attribute information generating unit 304 generates attribute information obtained by combining the feature amount and the keyword. The attribute information generating unit 304 supplies the attribute information to the retrieval information generating unit 305.

The retrieval information generating unit 305 generates retrieval information to be transmitted to the server 2, and generates retrieval information in which the image obtained from the image memory 301 and the attribute information of the image are associated with each other. The retrieval information is information showing retrieval conditions of a retrieval executed by the information retrieval apparatus 4. The information retrieval apparatus 4 can conduct a retrieval on the basis of not only an image but also a feature amount of the image and a keyword and can relatively easily determine what is the object in the image.

The retrieval information is first given to the display control unit 306 and, by the function of the display control unit 306, the details of the retrieval information are displayed on the display unit 32. On the display unit 32 at this time, an image transmitted as the retrieval information, the outer shape and color of the object included in the image, and the keyword which is set by the user are displayed, so that the user can check the retrieval information to be transmitted to the server.

When the user performs a predetermined transmitting operation on the operation unit 33, the retrieval information generating unit 305 outputs retrieval information to the communication unit 307.

The communication unit 307 has the function of performing data communication with the server 2 via the network 5 and transmits retrieval information obtained from the retrieval information generating unit 305 to the server 2. After that, when data is received from the server 2, the communication unit 307 supplies the data to the display control unit 306, thereby allowing the information based on the received data to be displayed on the display unit 32. For example, when notification of acknowledgment of reception of retrieval information is received from the server 2, a reception acknowledgment screen is displayed on the display unit 32. When answer information to the retrieval information is received from the server 2, an answer information display screen is displayed on the display unit 32.

The case where the terminal device 3 takes the form of a digital camera as shown in FIG. 3 will now be described. In this case, the terminal device 3b includes an image capturing unit 40, an image processing unit 41, an image memory 42, an image capturing control unit 43, a position detecting unit 44, a control unit 45, a display unit 46, an operation unit 47 and a communication unit 48.

The image capturing unit 40 functions as an image input part for inputting an image to be transmitted to the server 2 by taking a picture of a subject (object), and includes a lens 401 of which magnification can be changed and a CCD image capturing device 402 for generating an image signal. An image signal obtained by the CCD image capturing device 402 is outputted to the image processing unit 41 where the image signal is subjected to a predetermined image process, and a captured image is stored into the image memory 42.

The image capturing control unit 43 controls the image capturing unit 40. When the user operates the operation unit 47, according to the operation, the image capturing control unit 43 drives the lens 401 to change a focal length or controls an image capturing operation in the CCD image capturing device 402. The image capturing control unit 43 has a magnification detecting unit 431 and is constructed to detect a magnification β at the time point of the image capturing operation in the image capturing unit 40 and supplies the magnification β to the control unit 45. The magnification β can be computed from the focal length and a focus lens position of the lens 401.

The position detecting unit 44 takes the form of a GPS (Global Positioning System) or the like. For example, at the time of the image capturing operation of the image capturing unit 40, the position detecting unit 44 detects the present position of the terminal device 3 and generates position information. Therefore, according to the position information generated by the position detecting unit 44, the place where an image is obtained by the image capturing can be specified. The position information generated at the time of image capturing is supplied to the control unit 45.

The display unit 46 takes the form of a small liquid crystal display provided on the rear face of a digital camera or the like and the information displayed on the display unit 46 is controlled by the control unit 45. The operation unit 47 is an operation unit including a shutter start button for performing an image capturing operation and a magnification/reduction button for changing a focal length of the lens 401. Information inputted by the user is given to the control unit 45.

The control unit 45 is realized when the CPU executes a predetermined program. In order to perform an information retrieval based on an image, the control unit 45 functions as an attribute information generating unit 451 and a retrieval information generating unit 452.

When the magnification β and position information are inputted, the attribute information generating unit 451 generates attribute information obtained by combining the magnification β and the position information and supplies the attribute information to the retrieval information generating unit 452.

The retrieval information generating unit 452 for generating retrieval information to be sent to the server 2 generates retrieval information by associating an image obtained from the image memory 42 and the attribute information of the image obtained from the attribute information generating unit 451 with each other. By generating the retrieval information, the information retrieval apparatus 4 can perform a retrieval on the basis of not only an image but also the magnification β and the image capturing place of the image, so that the object in the image can be relatively easily determined. The retrieval information is supplied to the communication unit 48 and is transmitted to the server 2 by the function of the communication unit 48. At this time, a screen for checking the retrieval information may be displayed on the display unit 46.

The communication unit 48 has the function of performing data communication with the server 2 via the network 5 and transmits the retrieval information obtained from the retrieval information generating unit 452 to the server 2. After that, when data is received from the server 2, the communication unit 48 supplies the data to the control unit 45, thereby displaying information based on the received data on the display unit 46. For example, when reception acknowledgment notification of the retrieval information is received from the server 2, a reception acknowledgment screen is displayed on the display unit 46. When answer information to the retrieval information is received from the server 2, an answer information display screen is displayed on the display unit 46.

The case where the terminal device 3 takes the form of a dedicated terminal device as shown in FIG. 4 will now be described. In this case, the terminal device 3c is constructed by an image capturing unit 50, an image processing unit 51, an image memory 52, an image capturing control unit 53, a position detecting unit 54, a control unit 55, a display unit 56, an operation unit 57, a communication unit 58 and a keyword memory 59. In other words, the dedicated terminal device is different from the case where the terminal device 3 takes the form of a digital camera with respect to the points that the keyword memory 59 is further provided and the function of the control unit 55 is different.

The image capturing unit 50 functions as an image input part like in the case where the terminal device 3 is a digital camera. The image capturing unit 50 includes a lens 501 of which magnification can be changed and a CCD image capturing device 502 for generating an image signal. An image signal obtained by the CCD image capturing device 502 is outputted to the image processing unit 51 where the image signal is subjected to a predetermined image process and a captured image is stored into the image memory 52.

The image capturing control unit 53 controls the image capturing unit 50. When the user operates the operation unit 57, according to the operation, the image capturing control unit 53 drives the lens 501 to change the focal length and controls an image capturing operation in the CCD image capturing device 502. The image capturing control unit 53 is provided with a magnification detecting unit 531 and is constructed to detect the magnification β at the time point when the image capturing operation is performed in the image capturing unit 50 and to supply the detected magnification β to an attribute information generating unit 552.

The position detecting unit 54 detects the present position at the time of image capturing, generates position information, and supplies the generated information to the attribute information generating unit 552 in the control unit 55.

The display 56 takes the form of a small liquid crystal display or the like and information to be displayed is controlled by the control unit 55. The operation unit 57 is an operation unit including a shutter start button for performing an image capturing operation and an enlargement/reduction button for changing the focal length of the lens 501, and supplies information which is inputted by operation of the user to the control unit 55. The operation unit 57 is also provided with the function for setting a keyword for an image.

The keyword memory 59 is a memory in which a number of terms are stored and a list of the terms stored in the keyword memory 59 is displayed on the display unit 56 by the control unit 55. The user selects a term estimated as a term of an object included in an image from the list of a number of terms displayed on the display unit 56. The selecting operation by the user is performed on the operation unit 57. As a result, the term selected by the user is supplied as a keyword of the image to the attribute information generating unit 552 in the control unit 55.

An arbitrary keyword may be set in the attribute information generating unit 552 by not only selecting a keyword from the keyword memory 59 but also inputting an arbitrary keyword to the operation unit 57 by the user.

The control unit 55 is realized when the CPU executes a predetermined program and, in order to perform an information retrieval based on an image, the control unit 55 functions as an image feature amount extracting unit 551, the attribute information generating unit 552 and a retrieval information generating unit 553.

The image feature amount extracting unit 551 extracts a feature amount (for example, an outer shape, color or the like of an object included in an image) of an image obtained by image capturing. Concretely, by performing a contour extracting process on image data obtained from the image memory 52, the image feature amount extracting unit 551 extracts the outer shape of the object, obtains a color distribution on the inside of the outer shape, and uses the outer shape and the color distribution as feature amounts of the image. The feature amounts of the image extracted by the image feature amount extracting unit 551 are supplied to the attribute information generating unit 552.

When the magnification P from the magnification detecting unit 531, position information from the position detecting unit 54, a keyword which is set by the user, and an image feature amount from the image feature amount extracting unit 551 are inputted, the attribute information generating unit 552 generates attribute information obtained by combining the information pieces. The attribute information generating unit 552 gives the attribute information to the retrieval information generating unit 553.

The retrieval information generating unit 553 for generating retrieval information to be transmitted to the server 2 generates retrieval information by associating an image captured from the image memory 52 and attribute information of the image obtained from the attribute information generating unit 552. By generating the retrieval information, the information retrieval apparatus 4 can perform a retrieval on the basis of not only an image but also the attribute information such as the magnification β and the place of image capturing, so that the object in the image can be relatively easily determined. The retrieval information is supplied to the communication unit 58 and, by the function of the communication unit 58, transmitted to the server 2. A retrieval information acknowledgment screen may be displayed on the display unit 56.

The communication unit 58 has the function of performing a data communication with the server 2 via the network 5 and transmits retrieval information obtained from the retrieval information generating unit 553 to the server 2. After that, when data is received from the server 2, the communication unit 58 supplies the data to the control unit 55, thereby displaying information based on the received data on the display unit 56. For example, in the case where the retrieval information reception acknowledgment notification is received from the server 2, the reception acknowledgment screen is displayed on the display unit 56. In the case where answer information to the retrieval information is received from the server 2, the answer information display screen is displayed on the display unit 56.

The cases where the terminal device 3 takes the forms of a personal computer, a digital camera, and a dedicated terminal device have been described above. In the preferred embodiment, the function necessary for the terminal device 3 is a function of transmitting an image to be retrieved to the server 2. When the function of generating attribute information of each of the terminal devices 3 does not exist, it is sufficient to include only an image in retrieval information and transmit the resultant information to the server 2.

The retrieval information includes a retrieval request command for requesting the server 2 to perform an information retrieval based on an image.

3. Configuration of Server for Information Retrieval System

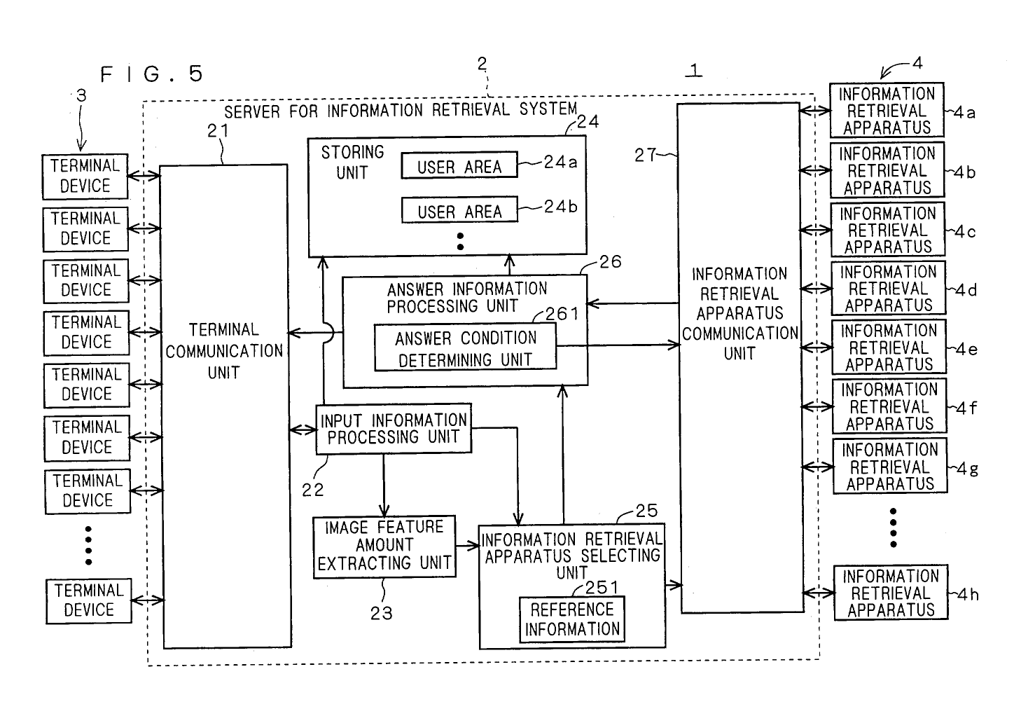

The configuration of the server 2 will now be described. FIG. 5 is a block diagram showing the configuration of the server 2. The server 2 is realized by the configuration of a general computer. When a CPU in the computer executes a predetermined program, the server 2 is provided with the functions of a terminal communication unit 21, an input information processing unit 22, an image feature amount extracting unit 23, a storing unit 24, an information retrieval apparatus selecting unit 25, an answer information processing unit 26 and an information retrieval apparatus communication unit 27.

The terminal communication unit 21 is a communication unit constructed so as to be able to perform data communication with each of a plurality of terminal devices 3 via the network 5. When information is received from the terminal device 3, the terminal communication unit 21 supplies the input information to the input information processing unit 22.

When the input information from the terminal device 3 is received, the input information processing unit 22 transmits reception acknowledgment notification to the terminal device 3 and analyzes the input information. When the input information is retrieval information, whether the attribute information is included in the retrieval information or not is determined. In the case where the attribute information is included, whether a feature amount of the image is included in the attribute information or not is determined. As a result, in the case where the feature amount of the image is included in the attribute information, the input information processing unit 22 supplies the retrieval information to the information retrieval apparatus selecting unit 25. On the other hand, when the feature amount of the image is not included in the attribute information, the input information processing unit 22 supplies the image included in the retrieval information to the image feature amount extracting unit 23 and supplies the retrieval information to the information retrieval apparatus selecting unit 25.

When retrieval information is received from the terminal device 3, the input information processing unit 22 sets user areas 24a, 24b, . . . in the storage unit 24. The storage unit 24 takes the form of a memory, a magnetic disk drive or the like. Each time the server 2 receives retrieval information from the terminal device 3, one user area is set. That is, each of the user areas 24a and 24b set in the storage unit 24 is a storage area corresponding to a retrieval job. When answer information is obtained from the information retrieval apparatus 4, the user area stores the answer information for predetermined time.

The image feature amount extracting unit 23 is to extract a feature amount of an image in the server 2 in the case where the feature amount of the image is not extracted in the terminal device 3. The image feature amount extracting unit 23 extracts a feature amount (for example, the outer shape, color or the like of an object included in an image) of an image included in the retrieval information. Concretely, by performing a contour extracting process on image data supplied from the input information processing unit 22, the outer shape of the object is extracted, a color distribution on the inside of the outer shape is obtained, and the outer shape and the color distribution are used as feature amounts of the image. The feature amounts of the image extracted by the image feature amount extracting unit 23 are supplied to the information retrieval apparatus selecting unit 25.

The information retrieval apparatus selecting unit 25 selects an information retrieval apparatus to perform an information retrieval on the retrieval information transmitted from the terminal device 3 from the plurality of information retrieval apparatuses 4. The information retrieval apparatus selecting unit 25 selects the information retrieval apparatus 4 to perform an information retrieval by referring to reference information 251 on the basis of the attribute information included in the retrieval information and the feature amount of the image obtained from the image feature amount extracting unit 23.

For example, in the case where the magnification β is included in the attribute information of the retrieval information, the information retrieval apparatus selecting unit 25 estimates the size of an object included in the image from the magnification β and selects the information retrieval apparatus 4 to perform an information retrieval on the basis of the size of the object.

More concretely, when the information retrieval apparatus 4a is an apparatus dedicated to perform an information retrieval on birds and the information retrieval apparatus 4b is an apparatus dedicated to perform an information retrieval on air planes, by estimating the size of an object from the magnification β, which one of the information retrieval apparatuses 4a and 4b is proper to be allowed to perform the information retrieval can be easily specified from the size of the object. Consequently, in the preferred embodiment, the information retrieval apparatuses 4 to execute an information retrieval can be narrowed down from the attribute information.

As the reference information 251 stored in the information retrieval apparatus selecting unit 25, information specified in classifications (specialties) which can be retrieved by each of the information retrieval apparatuses 4 is stored as a plurality of lookup tables or the like. Each lookup table is provided in correspondence with information included in the attribute information. Examples of the lookup tables are a lookup table for selecting an information retrieval apparatus in accordance with the size of an object, a lookup table for selecting an information retrieval apparatus in accordance with a place of image capturing, a lookup table for selecting an information retrieval apparatus in accordance with a keyword, and a lookup table for selecting an information retrieval apparatus in accordance with a feature amount of an image.

Consequently, in the case of referring to the reference information 251 on the basis of a keyword of, for example, “sky”, both of the information retrieval apparatus 4a dedicated to perform an information retrieval regarding birds and the information retrieval apparatus 4b dedicated to perform an information retrieval regarding air planes become objects to perform a retrieval. When the information retrieval apparatus selecting process is further performed in accordance with the size of the object based on the magnification β, the information retrieval apparatuses to execute a retrieval can be narrowed down.

Therefore, in the preferred embodiment, by performing the process of selecting the information retrieval apparatus 4 on the basis of all of the attribute information included in the retrieval information, the information retrieval apparatus selecting unit 25 can narrow the number of information retrieval apparatuses 4 to execute a retrieval from the plurality of information retrieval apparatuses 4. At this time, the narrowing operation is performed in consideration of the specialty of each of the information retrieval apparatuses 4, so that an efficient retrieval can be conducted and answer information of high reliability can be obtained.

The information retrieval apparatus selecting unit 25 outputs the retrieval information to the information retrieval apparatus communication unit 27 and instructs the information retrieval apparatus 4 to which the information is to be transmitted. The information retrieval apparatus selecting unit 25 makes the answer information processing unit 26 start performing an answer condition determining process.

The information retrieval apparatus communication unit 27 is a communication unit constructed so as to be able to perform data communication with each of the information retrieval apparatuses 4 via the network 6 and transmits retrieval information to the information retrieval apparatus 4 designated by the information retrieval apparatus selecting unit 25.

When answer information to the retrieval information is received from each of the information retrieval apparatuses 4, the information retrieval apparatus communication unit 27 transmits the received information to the answer information processing unit 26.

The answer information processing unit 26 has the function of, in the case of receiving the answer information from the information retrieval apparatus 4 to which the retrieval information is transmitted via the information retrieval apparatus communication unit 27, outputting the answer information to the terminal communication unit 21 so that the answer information is transmitted to the terminal device 3 as the transmitter of the retrieval information. The answer information processing unit 26 also has the function of recording the answer information into the corresponding user areas 24a and 24b in the storing unit 24. In the case where a plurality of answer information pieces are obtained in response to the retrieval information, the plurality of answer information pieces are consequently stored into the user areas 24a and 24b in the storing unit 24.

The answer information processing unit 26 is provided with an answer condition determining unit 261, transmits a retrieval condition to the information retrieval apparatus 4 and, after that, determines whether a predetermined answer condition is satisfied or not. The answer conditions are a lapse of predetermined time since retrieval information is transmitted to the information retrieval apparatus 4 selected by the information retrieval apparatus selecting unit 25 and reception of a predetermined number of answer information pieces. Each of the conditions is intended to prevent the retrieving process in the information retrieval apparatus 4 from being continued unlimitedly. When the answer condition determining unit 261 determines that the predetermined condition is satisfied when the predetermined time has elapsed after transmission of retrieval information or the predetermined number of answer information pieces is received, the answer condition determining unit 261 transmits a control signal for notifying that an answer is unnecessary to the information retrieval apparatus 4 to which the retrieval information has been transmitted.

Further, the answer information processing unit 26 has the function of counting user area set time from set time of the user areas 24a and 24b in the storing unit 24 and, when the user area set time becomes longer than the predetermined time, erasing the user area. By the function, a number of user areas can be prevented from being set in the storing unit 24 in the server 2, so that the storing unit 24 can be efficiently utilized.

When the server 2 receives the answer information reference command from the terminal device 3, the input information processing unit 22 specifies a user area, obtains answer information stored in the user area, and outputs the answer information to the terminal communication unit 21, thereby enabling all of the answer information stored in the user area to be transmitted in a lump to the terminal device 3. By the function, the answer information stored in the user area can be viewed in the terminal device 3.

As described above, in the server 2 of the preferred embodiment, when retrieval information including an image is received from the terminal device 3, execution of an information retrieval is not requested to all of the information retrieval apparatuses 4 but the information retrieval apparatus 4 is selected on the basis of the attribute information and execution of an information retrieval is requested to the selected information retrieval apparatus 4.

Consequently, very reliable answer information can be obtained and efficient retrieval can be performed.

4. Configuration of Information Retrieval Apparatus

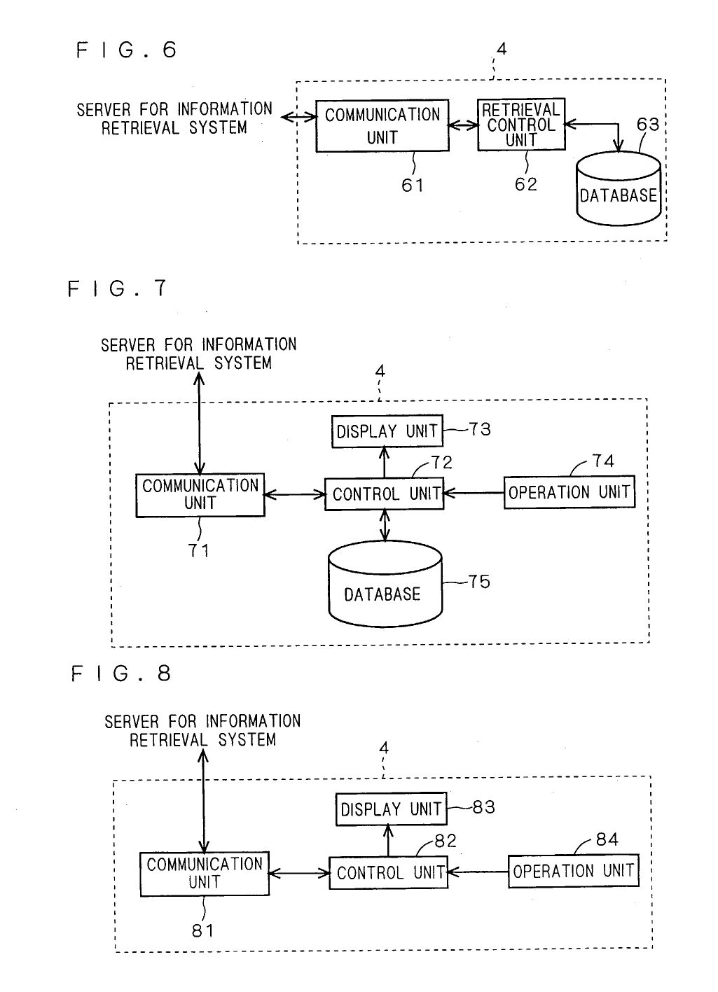

An example of the configuration of the information retrieval apparatus 4 will now be described. FIGS. 6 to 8 are block diagrams each showing an example of the configuration of the information retrieval apparatus 4. The information retrieval apparatus 4 having any of the configurations of FIGS. 6 to 8 may be employed and the information retrieval apparatus 4 with the other configurations may be also employed.

First, the information retrieval apparatus 4 shown in FIG. 6 includes a communication unit 61, a retrieval control unit 62, and a database 63. The communication unit 61 receives retrieval information from the server 2 and supplies it to the retrieval control unit 62. The retrieval control unit 62 automatically searches the database 63 on the basis of the retrieval information and generates answer information. A plurality of images are stored in the database 63 and the retrieval control unit 62 specifies an object in an image included in the retrieval information by, for example, matching an image included in the retrieval information with an image stored in the database 63. The attribute information included in the retrieval information may be used as auxiliary information for retrieval. By using the attribute information as the auxiliary information for retrieval, more reliable answer information can be generated. The answer information generated in the retrieval control unit 62 is transmitted to the server 2 via the communication unit 61.

The information retrieval apparatus 4 shown in FIG. 7 is realized by the configuration of a general computer having a communication unit 71, a control unit 72, a display unit 73, an operation unit 74 and a database 75. When retrieval information is received from the server 2, the communication unit 71 supplies it to the control unit 72. The control unit 72 displays an image based on the retrieval information on the display unit 73. The control unit 72 can also display a plurality of images stored in the database 75 on the basis of an instruction of the user which is inputted from the operation unit 74. The user of the information retrieval apparatus 4 performs an operation for generating answer information by the operation unit 74 with reference to an image stored in the database 75 and the retrieval information, thereby generating answer information in the control unit 72. By using the attribute information included in the retrieval information as auxiliary information for retrieval, more reliable answer information can be generated. The answer information generated in the control unit 72 is transmitted to the server 2 via the communication unit 71.

The information retrieval apparatus 4 shown in FIG. 8 is realized by the configuration of a general computer having a communication unit 81, a control unit 82, a display unit 83 and an operation unit 84. When retrieval information is received from the server 2, the communication unit 81 supplies the retrieval information to the control unit 82. The control unit 82 displays information based on the retrieval information on the display unit 83. By performing an inputting operation for generating answer information by the operation unit 84 with reference to an image, attribute information, and the like included in the retrieval information, answer information is generated in the control unit 82. That is, in the configuration shown in FIG. 8, the person who has expertise is the user of the information retrieval apparatus 4 and answer information based on the knowledge of the user is generated in the information retrieval apparatus 4. The answer information generated in the control unit 82 is transmitted to the server 2 via the communication unit 81.

As described above, when the retrieval information is received, the information retrieval apparatus 4 generates answer information indicating what is the image included in the retrieval information and transmits the answer information to the server 2.

The information retrieval apparatus 4 receives retrieval information from the server 2, starts performing a retrieval in response to the retrieval information, and continues the retrieval operation until a control signal notifying of an answer unnecessary state from the server 2 is received. Consequently, the present invention is not limited to the case where the information retrieval apparatus 4 generates only one answer information piece of the highest reliability on the basis of an image included in the retrieval information but the information retrieval apparatus 4 may generate a plurality of answer information pieces of reliability of a predetermined value or more.

5. Retrieval Sequence

A retrieval sequence in the case of performing an information retrieval based on an image in the information retrieval system 1 constructed as described above will now be described.

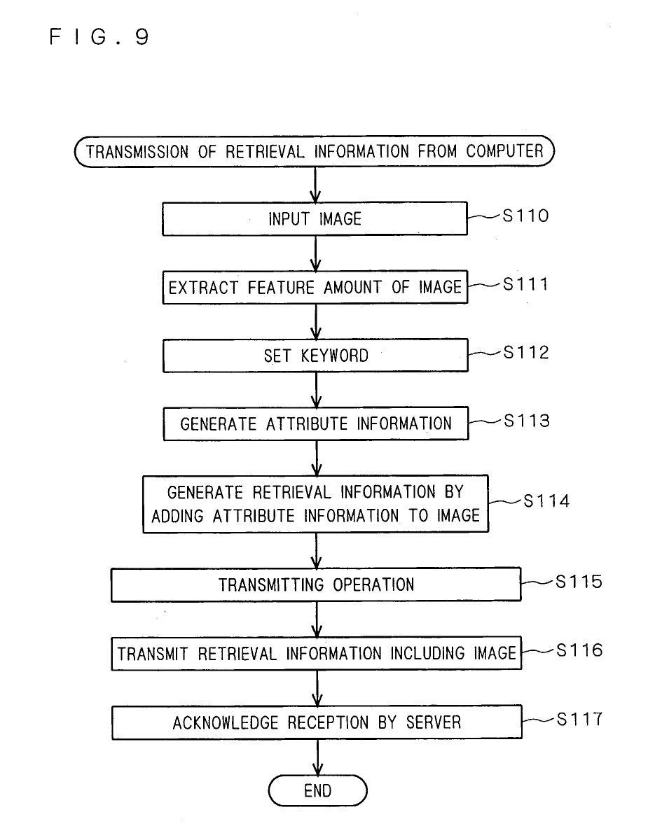

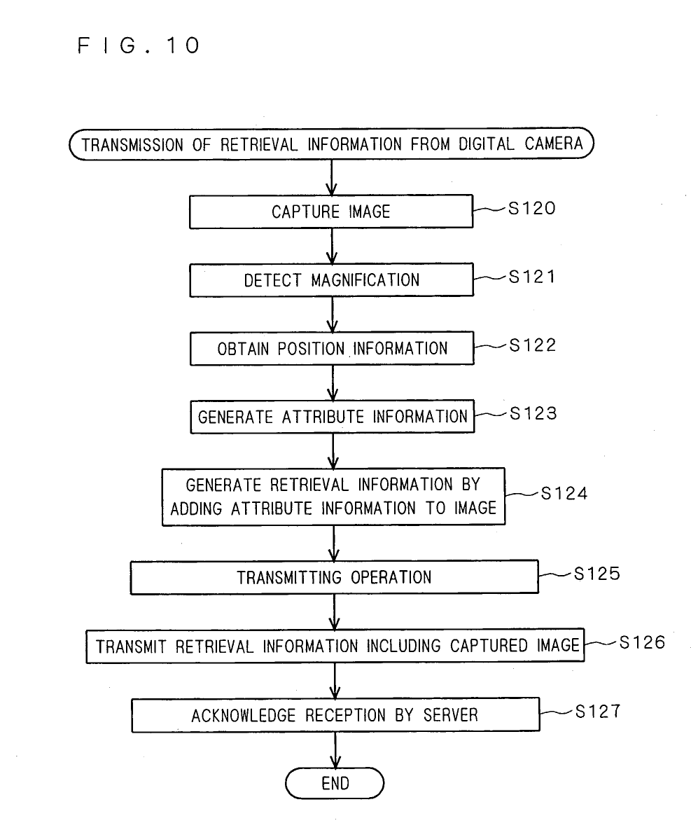

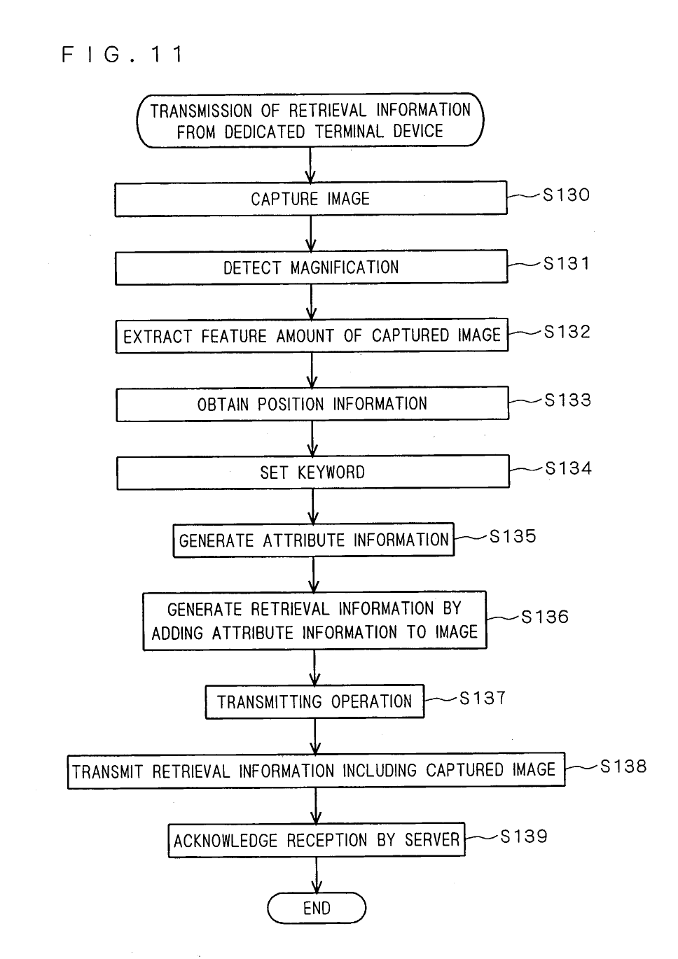

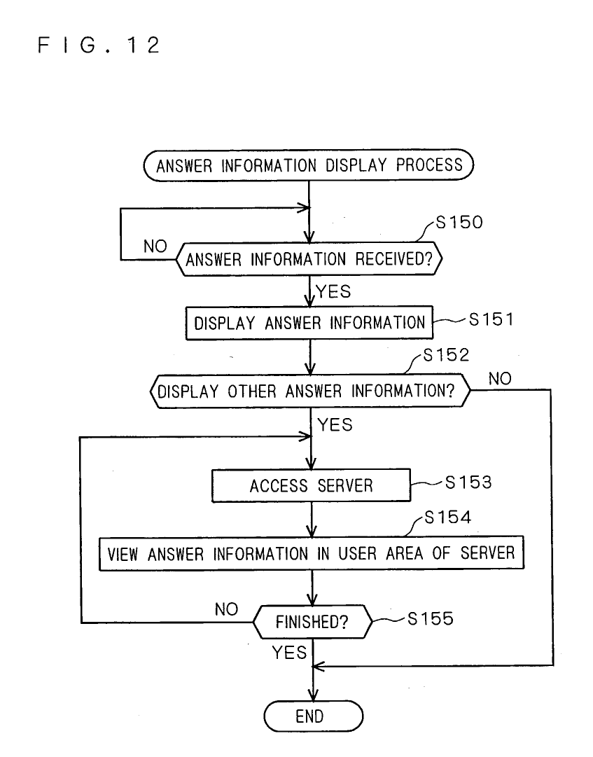

FIGS. 9 to 11 are flowcharts showing a processing sequence for transmitting retrieval information from the terminal device 3. To be specific, FIG. 9 shows a case where the terminal device 3 is a computer (see FIG. 2), FIG. 10 shows a case where the terminal device 3 is a digital camera (see FIG. 3), and FIG. 11 shows a case where the terminal device 3 is a dedicated terminal device (see FIG. 4).

First, the case where the terminal device 3 is a computer as shown in FIG. 2 will be described. As shown in FIG. 9, first, the terminal device 3a or 3d receives an image as an object of retrieval (step S110). A feature amount of the image is extracted (step S111) and a process of setting a keyword is performed (step S112). After that, attribute information is generated in the terminal device 3a or 3d (step S113) and is added to the image, thereby generating retrieval information (step S114). When the user performs an operation of transmitting the retrieval information on the terminal device 3a or 3d (step S115), the terminal device 3a or 3d transmits the retrieval information including the image to the server 2 (step S116). When reception in the server 2 is confirmed (step S117), the retrieval information transmitting process is finished.

The case where the terminal device 3 is a digital camera as shown in FIG. 3 will now be described. As shown in FIG. 10, the user of the terminal device 3b performs an operation of image capturing an object the user does not know. In response to the image capturing operation of the user, the terminal device 3b captures an image (step S120) and detects the magnification β at the time of image capturing (step S121). The position information at the time of image capturing is obtained from the position detecting unit 44 (step S122). After that, attribute information is generated in the terminal device 3b (step S123) and added to the image, thereby generating retrieval information (step S124). When the user performs a transmitting operation for transmitting the retrieval information to the terminal device 3b (step S125), the terminal device 3b transmits the retrieval information including the image to the server 2 (step S126). After the reception by the server 2 is confirmed (step S127), the retrieval information transmitting process is finished.

The case where the terminal device 3 is a dedicated terminal device as shown in FIG. 4 will now be described. As shown in FIG. 11, first, the user of the terminal device 3c performs an operation of image capturing an object the user does not know. In response to the image capturing operation of the user, the terminal device 3c captures an image (step S130) and detects the magnification β at the time of image capturing (step S131). Extraction of a feature amount of the captured image (step S132), acquisition of the position information at the time of image capturing (step S133), and setting of a keyword (step S134) are sequentially performed and, after that, attribute information is generated in the terminal device 3c (step S135). By adding the attribute information to the image, retrieval information is generated (step S136). When the user performs the transmitting operation for allowing the terminal device 3c to transmit the retrieval information (step S137), the terminal device 3c transmits the retrieval information including the image to the server 2 (step S138). After reception by the server 2 is acknowledged (step S139), the retrieval information transmitting process is finished.

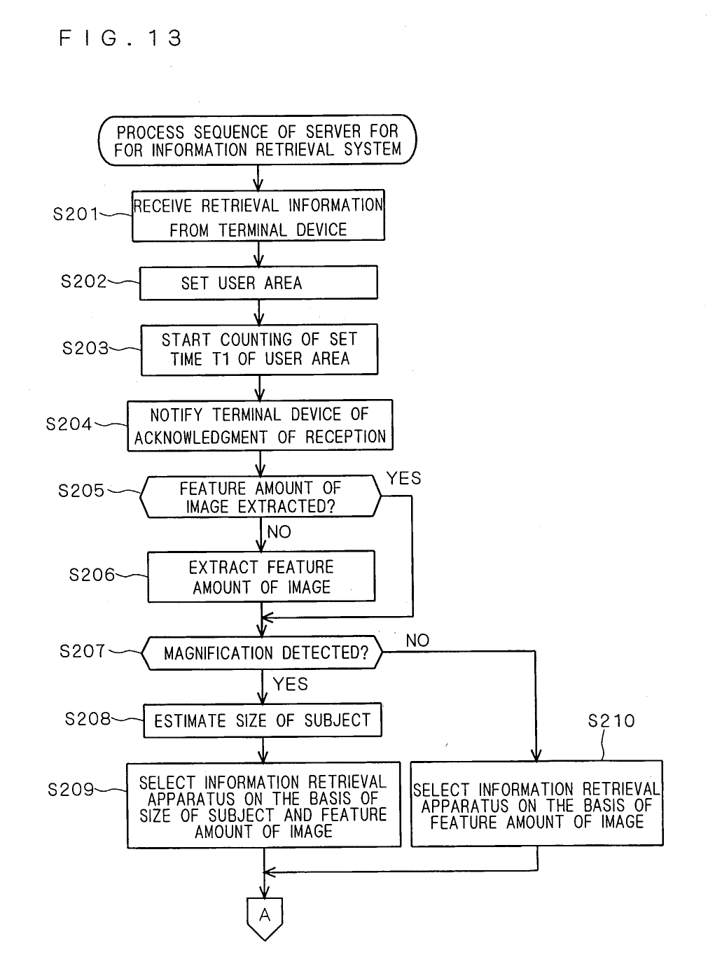

A processing sequence in the case where the terminal device 3 receives answer information to the retrieval information from the server 2 will now be described. FIG. 12 is a flowchart showing the processing sequence in the case where the terminal device 3 receives the answer information. The processing sequence can be applied to any of the cases where the terminal device 3 takes the forms of a computer, a digital camera and a dedicated terminal device.

Whether the terminal device 3 has received the answer information from the server 2 or not is determined (step S150). If YES, the answer information is displayed (step S151). By the answer information displayed, the user can recognize what the object the user did not know is. The user judges whether another answer information piece is to be displayed or not. If YES, a predetermined operation is performed (step S152). In the case where an operation for displaying other answer information is performed in the terminal device 3, the user accesses the server 2 (step S153) to view answer information stored in a user area which is set in the storing unit 24 of the server 2 (step S154). By the operation, when a plurality of answer information pieces are obtained in response to the retrieval information, the user can view the plurality of answer information pieces simultaneously. In the case where end of view is instructed by the user, the process is finished. When end of view is not instructed, the viewing process is repeated (step S155).

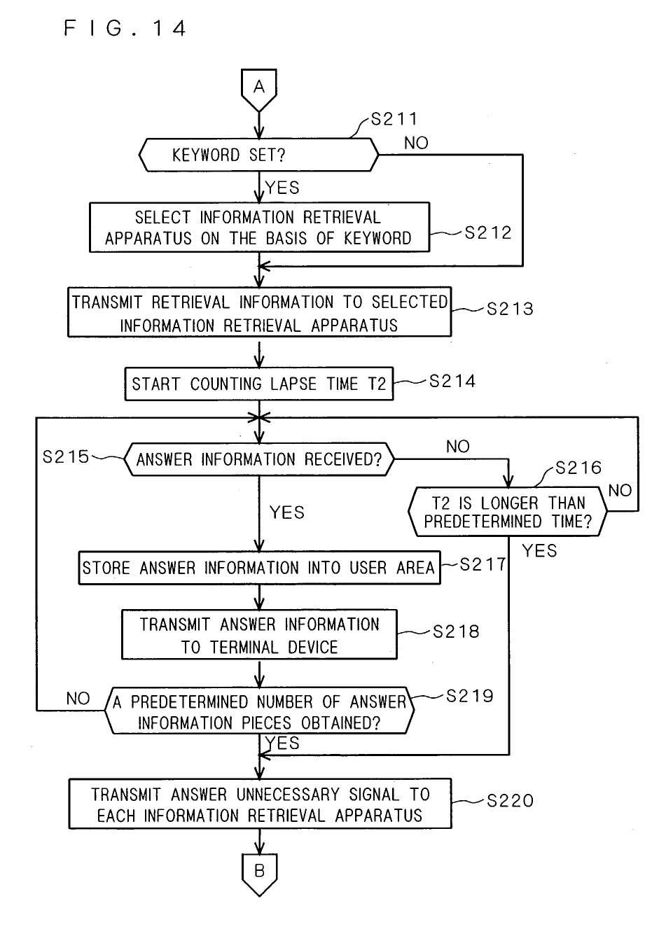

The processing sequence in the server 2 will now be described. FIGS. 13 to 15 are flowcharts showing the processing sequence in the server 2.

When the retrieval information is received from the terminal device 3 (step S201), the server 2 sets a user area in the storing unit 24 (step S202). The answer information processing unit 26 allows an operation of counting setting time T1 of the user area to be started (step S203) and the input information processing unit 22 transmits a notification of reception acknowledgment to the terminal device 3 as the sender of the retrieval information (step S204).

The input information processing unit 22 analyzes the details of the retrieval information and determines whether a feature amount of an image has already been extracted or not (step S205). In the case where a feature amount of the image has been already extracted on the terminal device 3 side, the program advances to step S207. On the other hand, when a feature amount of the image has not been extracted yet, the program advances to step S206 where the image feature amount extracting unit 23 functions to extract a feature amount of the image.

The input information processing unit 22 supplies the retrieval information to the information retrieval apparatus selecting unit 25. In the case where a feature amount of an image is extracted by the image feature amount extracting unit 23, the feature amount of the image is supplied to the information retrieval apparatus selecting unit 25.

The information retrieval apparatus selecting unit 25 determines whether there is information regarding the magnification β in the attribute information included in the retrieval information (step S207). If YES, the program advances to step S208. If NO, the program advances to step S210.

In the case where the magnification is included in the attribute information, the information retrieval apparatus selecting unit 25 estimates the size of the subject from the magnification β (step S208), refers to the reference information 251 on the basis of the size of the estimated subject and the feature amount of the image, and selects the information retrieval apparatus 4 as an object to which the retrieval information is transmitted from the plurality of information retrieval apparatuses 4 (step S209).

On the other hand, when the magnification is not included in the attribute information, the information retrieval apparatus selecting unit 25 refers to the reference information 251 on the basis of only the feature amount of the image, and selects the information retrieval apparatus 4 as an object to which the retrieval information is transmitted from the plurality of information retrieval apparatuses 4 (step S210).

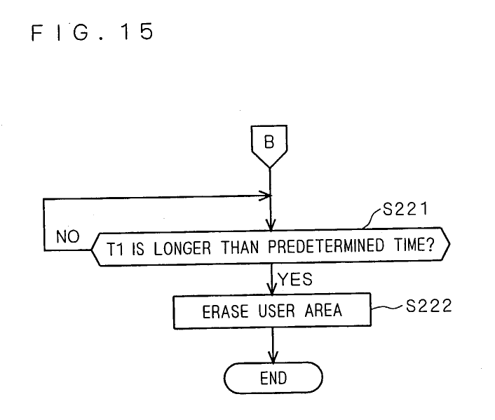

In step S211 shown in FIG. 14, the information retrieval apparatus selecting unit 25 determines whether a keyword is set in the attribute information or not (step S211). If YES, the information retrieval apparatus selecting unit 25 refers to the reference information 251 on the basis of the set keyword and performs a process of narrowing down the information retrieval apparatuses 4 (step S212).

At this time, in the case where the position information at the time of image capturing is included in the attribute information, the information retrieval apparatus selecting unit 25 refers to the reference information 251 on the basis of the position information and performs a process of further narrowing down the information retrieval apparatuses 4 as an object to which the retrieval information is transmitted from the plurality of information retrieval apparatuses 4.

By the selecting process and the narrowing process as described above, an information retrieval based on an image can be performed efficiently with high reliability. Each of the selecting process and the narrowing process of the information retrieval apparatus selecting unit 25 is performed on the basis of the magnification, image feature amount, keyword, and position information. The order of using the information pieces is arbitrary and is not limited to the above-described order.

The information retrieval apparatus selecting unit 25 designates the information retrieval apparatus 4 which is finally selected and outputs the retrieval information to the information retrieval apparatus communication unit 27, thereby transmitting the retrieval information to the selected information retrieval apparatus 4 (step S213). The answer condition determining unit 261 functions and starts an operation of counting a lapse time T2 since the retrieval information has been transmitted (step S214).

After the server 2 selects the information retrieval apparatus 4 and transmits the retrieval information to the selected apparatus, the server 2 enters a mode of waiting for answer information from the information retrieval apparatus 4 to which the retrieval information has been sent. Consequently, the answer information processing unit 26 determines whether the answer information has been received or not (step S215). If the answer information has not been obtained, the program advances to step S216 and the answer condition determining unit 261 determines whether the lapse time T2 becomes longer than predetermined time or not (step S216). If NO, the program returns to step S215 and waits for reception of answer information. If YES, the program advances to step S220 where the mode of waiting for the answer information is canceled.

In the case where the server 2 receives answer information from the information retrieval apparatus 4 before the lapse time T2 after transmission of the retrieval information becomes equal to or longer than the predetermined time, the answer information processing unit 26 stores the answer information into a corresponding user area in the storing unit 24 (step S217) and transmits the answer information to the terminal device 3 as the transmitter of the retrieval information (step S218). By the transmission of the answer information, the user of the terminal device 3 recognizes what is the object in the image the user did not know.

The answer condition determining unit 261 functions and determines whether a predetermined number of answer information pieces has been obtained or not (step S219). If NO, the program returns to step S215 and waits for receiving the next answer information. If YES, the program advances to step S220.

When the answer condition determining unit 261 determines that the predetermined answer condition is satisfied, an answer unnecessary signal is transmitted to each of the information retrieval apparatuses to which the retrieval information has been sent (step S220). It can prevent the retrieving process from being continued in each of the information retrieval apparatuses.

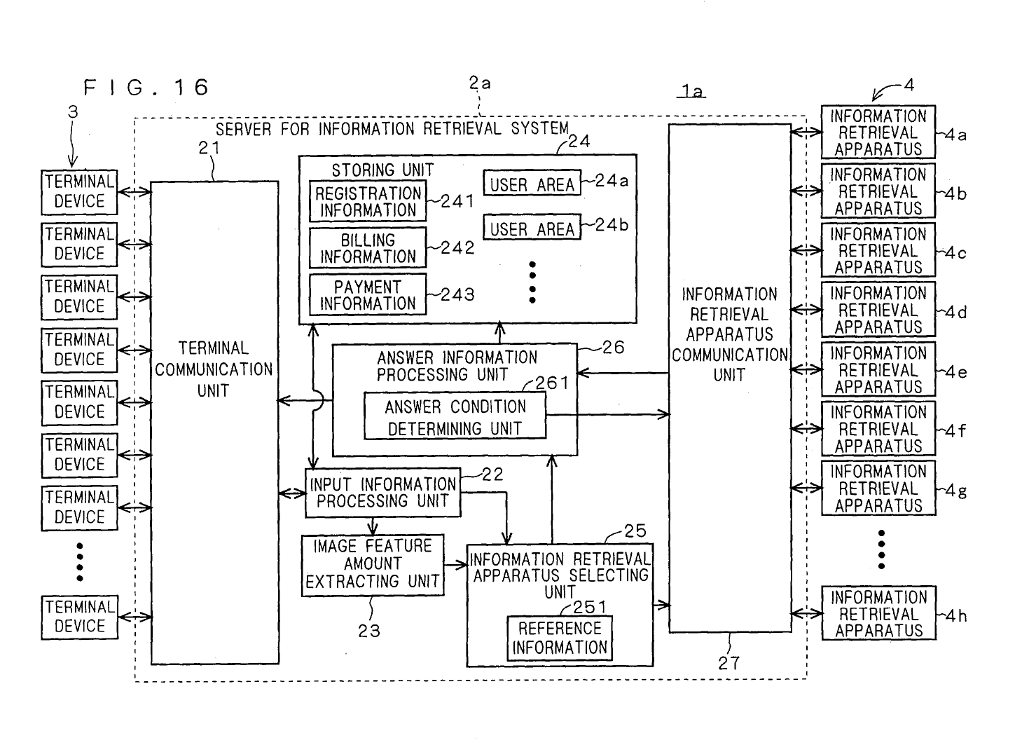

In step S221 in FIG. 15, whether the set time T1 in the user area becomes longer than the predetermined time or not is determined (step S221). If the set time T1 becomes longer than the predetermined time, the user area is deleted and the process is finished (step S222). When the set time T1 in the user area is not longer than the predetermined time in step S221, the user area is not deleted and it is realized so that the answer information stored in the user area can be viewed from the terminal device 3.

As described above, in the information retrieval system 1 of the preferred embodiment, for example, in the case where the user of a digital camera takes a picture of an object the user does not know on the outside, by generating retrieval information including the image and transmitting the resultant to the server 2, the user can easily know what the object in the image is. In other words, the user does not determine the object in the image taken by himself/herself but transmits retrieval information to the information retrieval apparatus 4 of the proper specialty in consideration of specialties of the plurality of information retrieval apparatuses 4 so that the information retrieval is performed. Thus, very reliable answer information can be efficiently obtained. Further, the user does not have to consult an illustrated reference book or the like by himself/herself, so that the burden on the user can be lessened.

Particularly, the server 2 selects at least one information retrieval apparatus 4 as an object to which the retrieval information is transmitted from the plurality of information retrieval apparatuses 4 on the basis of the retrieval information including an image, received from at least one of the plurality of terminal devices 3 and transmits retrieval information to the selected information retrieval apparatus 4. When answer information is received from the information retrieval apparatus to which the retrieval information is sent, the answer information is transmitted to the terminal device 3 which has generated the retrieval information. Thus, the information retrieval system 1 for efficiently obtaining very reliable answer information is realized. By the function of the server 2, each of the information retrieval apparatuses 4 can dedicate to an information retrieval, so that the process efficiency in the information retrieval apparatus 4 can be also improved.

The server 2 has the function of extracting a feature amount of an image included in the retrieval information and the function of storing reference information associated with each of a plurality of information retrieval apparatuses in accordance with the feature amount of the image. In the server 2, by selecting the information retrieval apparatus as an object to which the retrieval information is transmitted on the basis of the feature amount of the image and the reference information, the information retrieval apparatus 4 can be selected in consideration of the feature of the image. Consequently, the information retrieval apparatuses as objects of performing a retrieval can be narrowed down by using the feature of the image, so that the efficient information retrieval system 1 is realized.

In the case where the terminal device 3 has the function of extracting the feature amount of an image, generates retrieval information including an image and a feature amount of the image, and transmits it to the server 2, the process for extracting a feature amount of an image in the server 2 becomes unnecessary. Consequently, a process load on the server 2 is lessened and the retrieving process can be performed efficiently.

Further, in the case where the terminal device 3 is constructed to generate an image by performing an image capturing operation and has the function of obtaining a magnification at the time of the image capturing operation, the size of the subject can be estimated, so that the narrowing process according to the size of the subject can be performed at the time of performing the narrowing process of the information retrieval apparatus.

6. Configuration and Operation Sequence for Billing

A configuration for billing and a billing operation sequence in the information retrieval system 1 will now be described.

As a form of billing in the information retrieval system 1, first, there is a form of billing the user of the terminal device 3 who has requested for an information retrieval based on an image. Second, there is a form such that in the case where the plurality of information retrieval apparatuses 4 are mounted in different companies, addition of information for advertisement to the answer information from each information retrieval apparatus 4 is permitted and, when such answer information is transmitted to the terminal device 3, the user of the information retrieval apparatus 4 is charged.

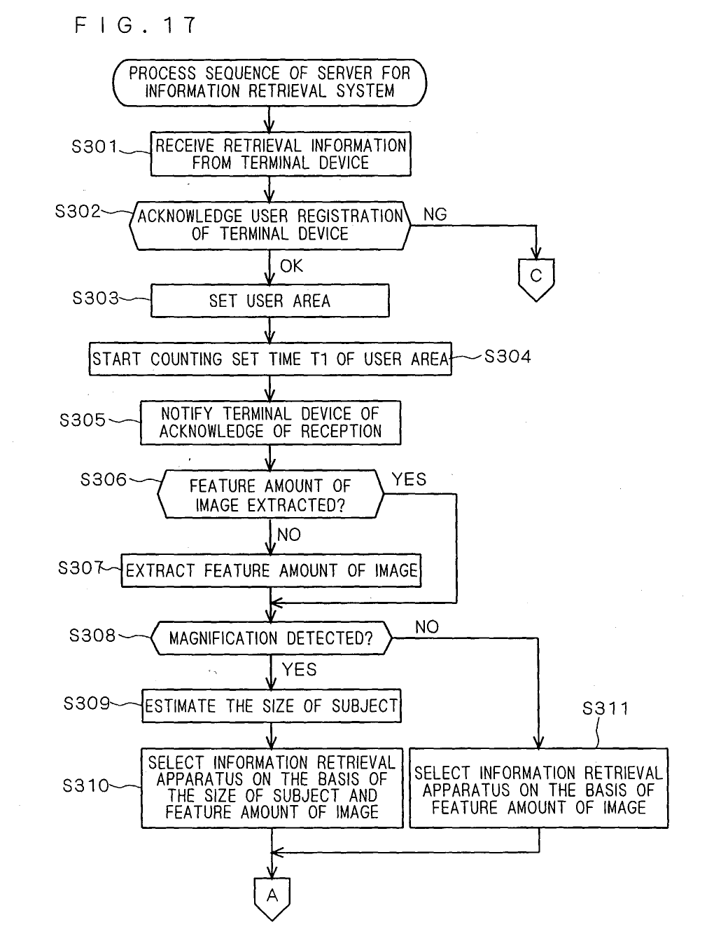

A configuration and an operation sequence for realizing the first billing form will be described. FIG. 16 is a block diagram showing the configuration of an information retrieval system 1 a for realizing the first billing form. In FIG. 16, components similar to those of the information retrieval system 1 shown in FIG. 5 are designated by the same reference numerals and their detailed description will not be repeated here.

In a server 2a of the information retrieval system 1a, in the storing unit 24, not only the user areas 24a and 24b but also registration information 241, billing information 242 and payment information 243 are stored.

The registration information 241 is information for preliminarily registering the users of the terminal devices 3 which can use the information retrieval system 1a and is preset by the user of the server 2a.

The billing information 242 is information for billing the user of the terminal device 3 in accordance with a use state of information retrieval service based on an image. The billing information 242 of each user is updated in accordance with the user area which is set in the storing unit 24.

The payment information 243 is information generated for paying compensation of the information retrieval from the user of the server 2a to the user of the information retrieval apparatus 4 and is updated when the server 2a receives the answer information from the information retrieval apparatus 4.

In the case where the server 2a receives the retrieval information from the terminal device 3, the input information processing unit 22 accesses the storing unit 24 to obtain the registration information 241, determines whether the user of the terminal device 3 requesting a retrieval is registered in the registration information 241 or not, if the user is a registered user, performs the process of selecting the information retrieval apparatus 4, and transmits the retrieval information to the selected information retrieval apparatus 4. If the user is not a registered user, the retrieval information received by the server 2a is erased.

The answer information processing unit 26 stores answer information received from the information retrieval apparatus 4 into a corresponding user area in the storing unit 24 and transmits answer information to the terminal device 3 as the transmitter of the retrieval information. At this time, the answer information processing unit 26 generates payment information to the user of the information retrieval apparatus 4 as the transmitter of the answer information and updates the payment information 243 stored in the storing unit 24.

In the case where it is set to receive a plurality of answer information pieces in the answer condition determining unit 261 in the answer information processing unit 26, the answer information processing unit 26 sets a payment amount of the payment information generated on receipt of the first answer information to the highest amount. When answer information is received after that, payment information is generated so that the payment amount gradually decreases in accordance with the order of reception. For fast transmission of answer information, the payment amount for the information retrieval apparatus is set to a high amount. In the case where transmission of answer information is later than the other information retrieval apparatus, a lower payment amount is set. In such a manner, competition among a plurality of information retrieval apparatuses can be promoted and, as a result, the user of the terminal device 3 can obtain answer information fast.

In the case where it is set to receive a plurality of answer information pieces, it is also possible to construct so that the answer information processing unit 26 receives only answer information different from the answer information which is obtained first. With such a configuration, payment for the same answer information can be prevent and the answer information can be corrected to answer information which is more reliable than the first answer information. Thus, improvement in reliability in the information retrieval can be realized.

In the case where the answer condition determining unit 261 in the answer information processing unit 26 is set to receive one piece of answer information, only when answer information is received for the first time, the answer information processing unit 26 generates payment information to the user of the information retrieval apparatus 4 and updates the payment information 243 to be stored in the storing unit 24. Also by setting payment information to the information retrieval apparatus only when the answer information is transmitted for the first time, competition among the plurality of information retrieval apparatuses can be promoted. As a result, the user of the terminal device 3 can obtain answer information fast.

When the set time T1 of a user area becomes longer than the predetermined time, the answer information processing unit 26 erases the user area from the storing unit 24. At the time of erasing the user area, the answer information processing unit 26 generates billing information to the user of the terminal device 3 which has occupied the user area and updates the billing information 242 stored in the storing unit 24.

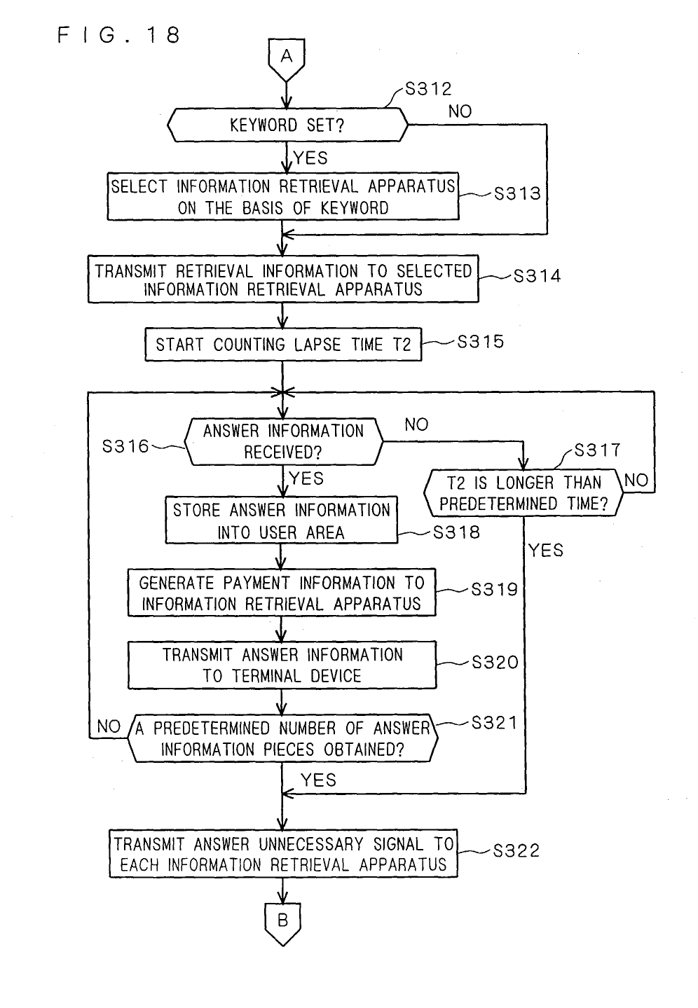

The process sequence in the server 2a of the information retrieval system 1a as described above will now be described. FIGS. 17 to 19 are flowcharts showing the process sequence in the server 2a.

The server 2a receives retrieval information from the terminal device 3 (step S301) and checks whether the user of the terminal device 3 is registered or not by referring to the registration information 241 stored in the storing unit 24 (step S302). In the case where the user of the terminal device 3 is not registered, the processing sequence for retrieval is finished. On the other hand, in the case where the user of the terminal device 3 is registered, a user area is set in the storing unit 24 (step S303). The answer information processing unit 26 starts an operation of counting the set time T1 of the user area (step S304) and the input information processing unit 22 transmits reception acknowledgment notification to the terminal device 3 as the transmitter of the retrieval information (step S305).

The input information processing unit 22 analyzes the details of the retrieval information and determines whether a feature amount of the image has been already extracted or not (step S306). In the case where a feature amount of the image has been already extracted on the terminal device 3 side, the program advances to step S308. On the other hand, when a feature amount of the image has not been extracted, the program advances to step S307 where the image feature amount extracting unit 23 functions to extract a feature amount of the image.

The input information processing unit 22 supplies retrieval information to the information retrieval apparatus selecting unit 25 and, in the case where a feature amount of an image is extracted in the image feature amount extracting unit 23, supplies the feature amount of the image to the information retrieval apparatus selecting unit 25.

The information retrieval apparatus selecting unit 25 determines whether there is information regarding the magnification β in the attribute information included in the retrieval information or not (step S308), if YES, advances to step S309 and, if NO, advances to step S311.

In the case where the magnification is included in the attribute information, the information retrieval apparatus selecting unit 25 estimates the size of the subject from the magnification β (step S309), refers to the reference information 251 on the basis of the size of the estimated subject and the feature amount of the image and selects the information retrieval apparatus 4 as an object to which the retrieval information is transmitted from the plurality of information retrieval apparatuses 4 (step S310).

On the other hand, when the magnification is not included in the attribute information, the information retrieval apparatus selecting unit 25 refers to the reference information 251 on the basis of only the feature amount of the image and selects the information retrieval apparatus 4 as an object to which the retrieval information is transmitted from the plurality of information retrieval apparatuses 4 (step S311).

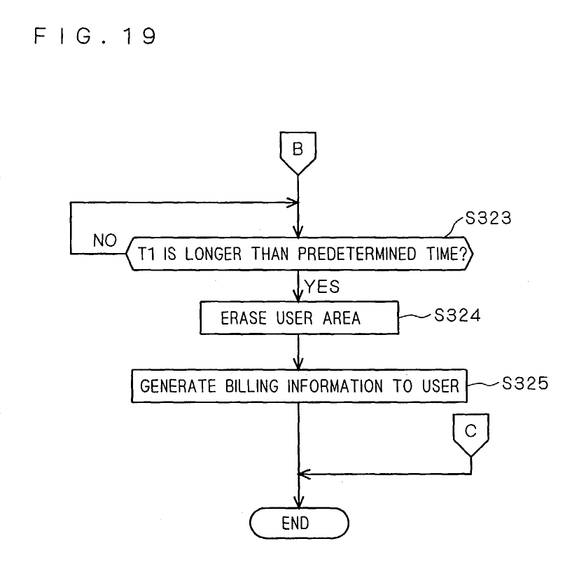

In step S312 shown in FIG. 18, the information retrieval apparatus selecting unit 25 determines whether a keyword is set in the attribute information or not (step S312). In the case where a keyword is set, the reference information 251 is referred to on the basis of the set keyword and the process of narrowing the information retrieval apparatuses 4 is performed (step S313).

In the case where position information at the time of image capturing is included in the attribute information, the information retrieval apparatus selecting unit 25 refers to the reference information 251 on the basis of the position information and performs a process of further narrowing the information retrieval apparatuses 4 as objects to which retrieval information is transmitted from the plurality of information retrieval apparatuses 4.

By such selecting and narrowing processes, the information retrieval based on an image can be performed efficiently with high reliability.

The information retrieval apparatus selecting unit 25 designates the information retrieval apparatus 4 finally selected and outputs the retrieval information to the information retrieval apparatus communication unit 27, thereby transmitting the retrieval information to the selected information retrieval apparatus 4 (step S314). The answer condition determining unit 261 functions to start counting the lapse time T2 since the retrieval information is transmitted (step S315).

The server 2a selects the information retrieval apparatus 4, transmits retrieval information and, after that, enters a mode of waiting for answer information from the information retrieval apparatus 4 to which the retrieval information is transmitted. The answer information processing unit 26 determines whether answer information has been received or not (step S316). If NO, the program advances to step S317 and whether the lapse time T2 becomes longer than the predetermined time or not is determined in the answer condition determining unit 261 (step S317). In the case where the lapse time T2 is not longer than the predetermined time, the program returns to step S316 and waits for reception of answer information. In the case where the lapse time T2 becomes longer than the predetermined time, the program advances to step S322 where the mode of waiting for answer information is canceled.

In the case where the server 2a receives answer information from the information retrieval apparatus 4 before the lapse time T2 becomes longer than predetermined time since the retrieval information is transmitted, the answer information processing unit 26 stores answer information into a corresponding user area in the storing unit 24 (step S318), generates payment information to the information retrieval apparatus 4 as the sender of the answer information, and updates the payment information 243 stored in the storing unit 24 (step S319). The answer information is transmitted to the terminal device 3 as the transmitter of the retrieval information (step S320).

The answer condition determining unit 261 functions and determines whether a predetermined number of answer information pieces has been obtained or not (step S321). If NO, the program returns to step S316 and waits for reception of the next answer information. If YES, the program advances to step S322.

In the case where the answer condition determining unit 261 determines that a predetermined answer condition has been satisfied, an answer unnecessary signal is transmitted to each of the information retrieval apparatuses to which retrieval information is transmitted (step S322) to prevent the retrieval process from being continued in each of the information retrieval apparatuses.

In step S323 in FIG. 19, whether the set time T1 of the user area becomes longer than the predetermined time or not is determined (step S323). If YES, the user area is erased (step S324). Billing information to the user of the terminal device 3 is generated and the billing information 242 stored in the storing unit 24 is updated (step S325).

As described above, in the information retrieval system 1a, a billing system for billing the user of the terminal device 3 requesting an information retrieval based on an image by the server 2a and paying compensation for the information retrieval to the user of the information retrieval apparatus 4 actually executing an information retrieval is realized.

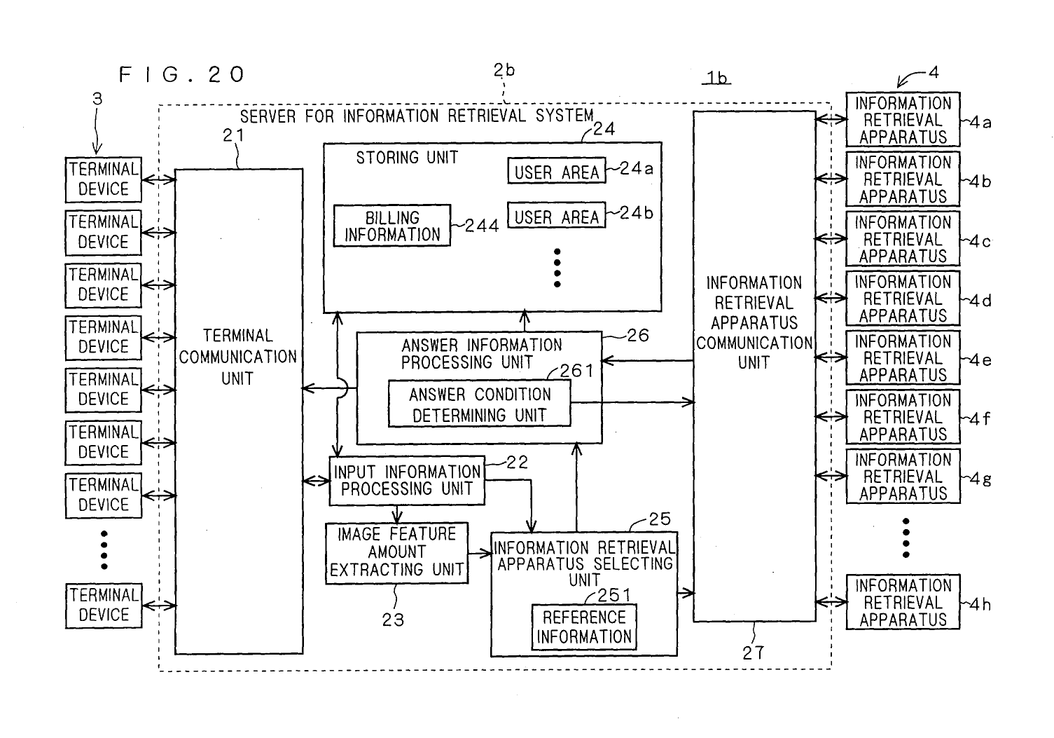

A configuration and an operation sequence for realizing the second billing form will now be described. FIG. 20 is a block diagram showing the configuration of an information retrieval system 1b for realizing the second billing form. In FIG. 20, components similar to those of the information retrieval system 1 shown in FIG. 5 are designated by the same reference numerals and their detailed description will not be repeated here.

In a server 2b of the information retrieval system 1b, in the storing unit 24, not only the user areas 24a and 24b but also billing information 244 are stored.

The billing information 244 is information for billing the user of the information retrieval apparatus 4 and is updated each time answer information with an advertisement is transmitted to the terminal device 3.

Specifically, in the case where the server 2b receives retrieval information from the terminal device 3, selects the information retrieval apparatus 4, and transmits the retrieval information to the selected information retrieval apparatus 4, the information retrieval apparatus 4 which has received a retrieval request adds advertisement information of a product of its company at the time of generating answer information. When the server 2b transmits the answer information with the advertisement to the terminal device 3, the server 2b generates billing information for the user of the information retrieval apparatus 4 as an advertisement fee.

For example, the user of the terminal device 3 goes out, is interested in a bag someone carries, and wishes to purchase the bag. In this case, the user photographs the bag by using the terminal device 3 and transmits retrieval information including the captured image to the server 2b. The server 2b selects the information retrieval apparatus 4 and transmits the retrieval information as described above. When the information retrieval apparatus 4 determines that the image of the bag included in the retrieval information is the bag of the company of the information retrieval apparatus 4, detailed information regarding the bag is generated as answer information and advertisement information of the price, sales shops, and the like of the bag is added to the answer information. At the time of transmitting the answer information to which such advertisement information is added to the terminal device 3, the server 2b generates billing information and updates the billing information 244 stored in the storing unit 24.

The processing sequence in the server 2b of the information retrieval system 1b is almost similar to that of the flowcharts of FIGS. 13 to 15 except that, in the flowchart of FIG. 14, when the server 2b transmits answer information with an advertisement to the terminal device 3 (step S218), the process of generating billing information to the information retrieval apparatus 4 and updating the billing information 244 included in the storing unit 24 is performed.

As described above, in the information retrieval system 1b, the billing system which does not bill the user of the terminal device 3 requesting an information retrieval based on an image but bill the user of the information retrieval apparatus 4 for generating answer information added with advertisement information is realized.

7. Modifications

Although the preferred embodiments of the present invention have been described above, the present invention is not limited to the above embodiments.

Although the example of extracting the outer shape and color of an object included in an image as feature amounts of the image has been described above, the present invention is not limited to the example. It is also possible to extract a frequency component of an image or the like as a feature amount and perform a process of narrowing down the information retrieval apparatuses 4 on the basis of the frequency component of the image in the server 2, 2a, or 2b.

Although the case where the server 2, 2a, or 2b and the plurality of information retrieval apparatuses 4 are separately constructed has been described above, the components may be realized by a single computer. In this case, each of the information retrieval apparatuses 4 is constructed by a database or the like for automatically performing an information retrieval.

The case where the terminal device 3 takes the form of a digital camera (see FIG. 3) and the case where the digital camera 3b has the communication unit 48 so as to perform a data communication directly with the server 2, 2a, or 2b has been described. However, the digital camera 3b and an apparatus having the communication function may be constructed as separate members.

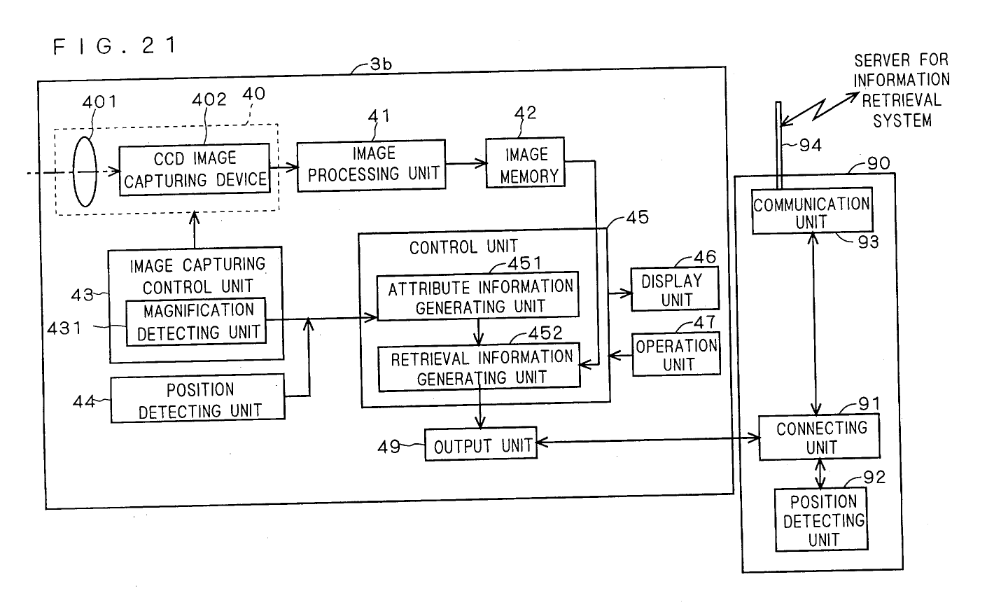

FIG. 21 is a diagram showing an example of the case where the digital camera 3b and a communication function of performing communication with the server 2, 2a, or 2b are provided as separate members. As shown in FIG. 21, the terminal device 3b is constructed so that a communication device 90 can be connected to an output unit 49. When retrieval information is generated in the terminal device 3b, the retrieval information is supplied to the output unit 49 and the output unit 49 outputs the retrieval information to the communication device 90 taking the form of a portable telephone or the like. In the communication device 90, a connection unit 91 receives retrieval information and supplies it to a communication unit 93. The communication unit 93 transmits the retrieval information to the server 2, 2a, or 2b via an antenna 94.

With such a configuration, it becomes unnecessary to provide the terminal device 3b with the communication part for performing data communication directly with the server 2, 2a or 2b. As shown in FIG. 21, a portable telephone or the like having a position detecting unit 92 such as a GPS in recent years is being realized. Consequently, it is also possible to provide the communication device 90 with the position detecting unit 92, supply position information from the communication device 90 to the terminal device 3b, and include the position information into the attribute information in the terminal device 3b.

The configuration shown in FIG. 21 is not limited to the case where the terminal device 3 takes the form of a digital camera but can be also applied to the other case such that the function of performing communication with a server is provided for a separate apparatus. The communication device 90 is not limited to a portable telephone but a similar function may be realized by attaching a card-type communication apparatus having a communication function into a memory card slot or the like in a digital camera.

While the invention has been shown and described in detail, the foregoing description is in all aspects illustrative and not restrictive. It is therefore understood that numerous modifications and variations can be devised without departing from the scope of the invention.

What is claimed is:

1. A server for information retrieval, comprising:
a first interface for performing data communication with a plurality of terminal devices;
a second interface for performing data communication with a plurality of information retrieval apparatuses;
an input unit for inputting retrieval information including an image from at least one of said plurality of terminal devices via said first interface;
a selector for selecting at least one information retrieval apparatus as an object to which said retrieval information is transmitted from said plurality of information retrieval apparatuses on the basis of the retrieval information inputted from said input unit;
a first transmitter for transmitting said retrieval information to the information retrieval apparatus selected by said selector via said second interface;
a receiver for receiving retrieval result information via said second interface from said information retrieval apparatus to which said retrieval information is transmitted from said first transmitter; and
a second transmitter for transmitting said retrieval result information via said first interface to said terminal device which has transmitted said retrieval information.

2. The server according to claim 1, wherein
after a lapse of predetermined time since transmission of said retrieval information, said first transmitter further transmits information indicating that it is unnecessary to perform a search to the information retrieval apparatus selected by said selector.

3. The server according to claim 1, wherein
when a predetermined number of items of retrieval result information are received from said information retrieval apparatus, said first transmitter further transmits information indicating that it is unnecessary to perform a search to the information retrieval apparatus selected by said selector.

4. The server according to claim 1, further comprising:
a detector for detecting information regarding said image included in said retrieval information; and
a memory for storing reference information with which each of said plurality of information retrieval apparatuses is associated in accordance with said information regarding said image detected by said detector, wherein
said selector selects at least one information retrieval apparatus as an object to which said retrieval information is transmitted on the basis of said information regarding said image and said reference information.

5. The server according to claim 4, wherein
said information regarding said image is information indicative of at least one of contour, color and frequency characteristic of said image.

6. The server according to claim 4, wherein
said information regarding said image is a magnification of said image.

7. The server according to claim 4, wherein
said information regarding said image is information of a photographing position of said image.

8. The server according to claim 1, wherein
said plurality of information retrieval apparatuses are connected to said second interface, and categories of images which can be retrieved by said plurality of apparatuses are different from each other.

9. The server according to claim 1, wherein
said retrieval result information is information indicating that said image included in said retrieval information is specified in said information retrieval apparatus to which said retrieval information has been transmitted.

10. The server according to claim 1, wherein
said information retrieval apparatus has an image database and specifies an image included in said retrieval information by matching the image included in said retrieval information with an image stored in said image database.

11. The server according to claim 1, further comprising:
a billing information generator for generating information of billing regarding a retrieval.

12. An information retrieving method in a server for performing data communication with a plurality of terminal devices via a first interface and performing data communication with a plurality of information retrieval apparatuses via a second interface, the method comprising the steps of:
receiving retrieval information including an image from at least one of said plurality of terminal devices via said first interface;
selecting at least one information retrieval apparatus as an object to which said retrieval information is transmitted from said plurality of information retrieval apparatuses on the basis of said retrieval information inputted;
transmitting said retrieval information to said information retrieval apparatus selected via said second interface;
receiving retrieval result information via said second interface from said information retrieval apparatus to which said retrieval information has been transmitted; and
transmitting said retrieval result information via said first interface to said terminal device which has transmitted said retrieval information.

13. A terminal device capable of performing data communication via a network with a server which performs data communication with a plurality of information retrieval apparatuses, comprising:
an image input unit for inputting an image;
a detector for detecting information regarding said image received from said image input unit;
a retrieval information generator for generating retrieval information including said image received from said image input unit and said information regarding said image detected by said detector; and
a transmitter for transmitting said retrieval information generated by said retrieval information generator to said server.

14. The terminal device according to claim 13, wherein
said information regarding said image is information indicative of at least one of contour, color and frequency characteristic of said image.

15. The terminal device according to claim 13, wherein
said image input unit is an image generator for generating said image by performing a photographing operation, and said information regarding said image is a magnification at the time of photographing by said image generator.

16. The terminal device according to claim 13, wherein
said image input unit is an image generator for generating said image by performing a photographing operation, and said information regarding said image is information of a photographing position at the time of photographing operation performed by said image generator.

17. The terminal device according to claim 13, further comprising:
an operation unit for inputting a keyword regarding said image, wherein
said retrieval information generator generates retrieval information including said keyword.

18. The terminal device according to claim 13, wherein
said server can perform data communication with each of a plurality of terminal devices and a plurality of information retrieval apparatuses, and retrieval information transmitted to said server is transmitted to at least one of said plurality of information retrieval apparatuses.

19. A method of generating retrieval information in a terminal device capable of performing data communication via a network with a server performing data communication with a plurality of information retrieval apparatuses, the method comprising the steps of:
inputting an image;
detecting information regarding said image inputted;
generating retrieval information including said image inputted and information regarding said image detected; and
transmitting said retrieval information generated to said server.
